(19) United States
(12) Patent Application Publication
(10) Pub. No.: US 2013/0223004 A1
(43) Pub. Date: Aug. 29, 2013

(54) SERVER CASE

(71) Applicant: KUEI-CHIH HOU, Tu-Cheng (TW)

(72) Inventor: KUEI-CHIH HOU, Tu-Cheng (TW)

(73) Assignee: HON HAI PRECISION INDUSTRY CO., LTD., Tu-Cheng (TW)

(21) Appl. No.: 13/457,694

(22) Filed: Apr. 27, 2012

(30) Foreign Application Priority Data
Feb. 29, 2012 (TW) 101106452

(51) Int. Cl. G06F 1/20

(52) U.S. Cl. 361/679.48

(57) ABSTRACT

A server case includes a main body, a fan module, a power supply and a system module. The fan module is fixed at one end of the main body. The fan module includes a front wall facing the main body, a plurality of system interfaces and a plurality of first power interfaces defined in the front wall. The power supply device includes a plurality of second power interfaces corresponding to the first power interfaces. The system module includes a plurality of golden fingers corresponding to the system interfaces. The second power interfaces and the golden fingers are alternatively inserted into the first power interfaces and the system interfaces so the power supply device and the system module are alternatively and electrically connected to the fan module.

### BACKGROUND

1. Technical Field

This disclosure relates to sever cases, and in particular, to a sever case having a adjustable power supply device.

2. Description of Related Art

A server may include a server case and a power supply permanently located at a rear portion of the server case. The power supply is connected to an outer power source to supply electricity to the server. However, the power supply is permanently fixed to the server so it cannot be adjusted to meet other requirements.

Therefore, there is a room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary server case. Moreover, in the drawings like reference numerals designate corresponding parts throughout the several views. Wherever possible, the same reference numbers are used throughout the drawings to refer to the same or like elements of an embodiment.

FIG. 1 is a schematic view of a server case with a power supply device and a system module according to an exemplary embodiment.

FIG. 2 is an exploded view of the sever case of FIG. 1.

FIG. 3 is a schematic view of the sever case of FIG. 1 only with the power supply device.

FIG. 4 is an exploded view of the sever case of FIG. 3.

FIG. 5 is a schematic view of the sever case of FIG. 1 only with the system module.

FIG. 6 is an exploded view of the sever case of FIG. 5.

FIG. 7 is a plan view of a fan module of the sever case.

FIG. 8 is a diagram of the fan module.

FIG. 9 is a diagram of the power supply device.

FIG. 10 is a diagram of the system module.

### DETAILED DESCRIPTION

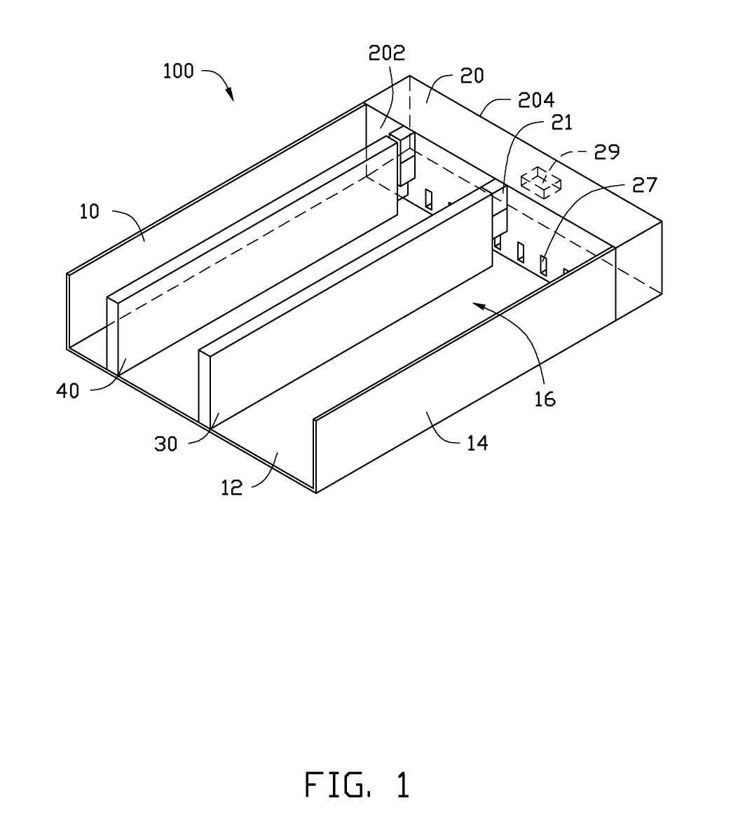

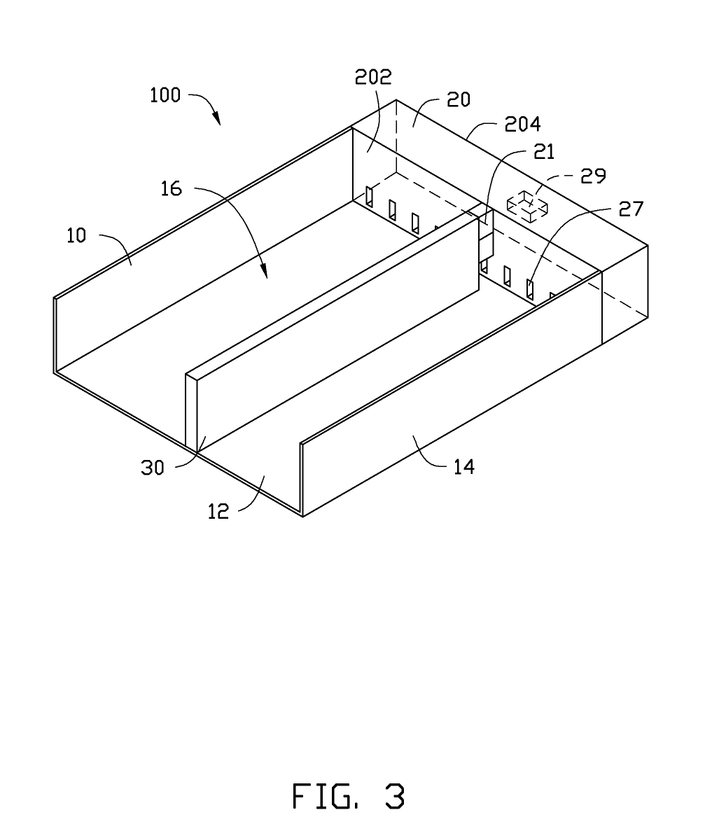

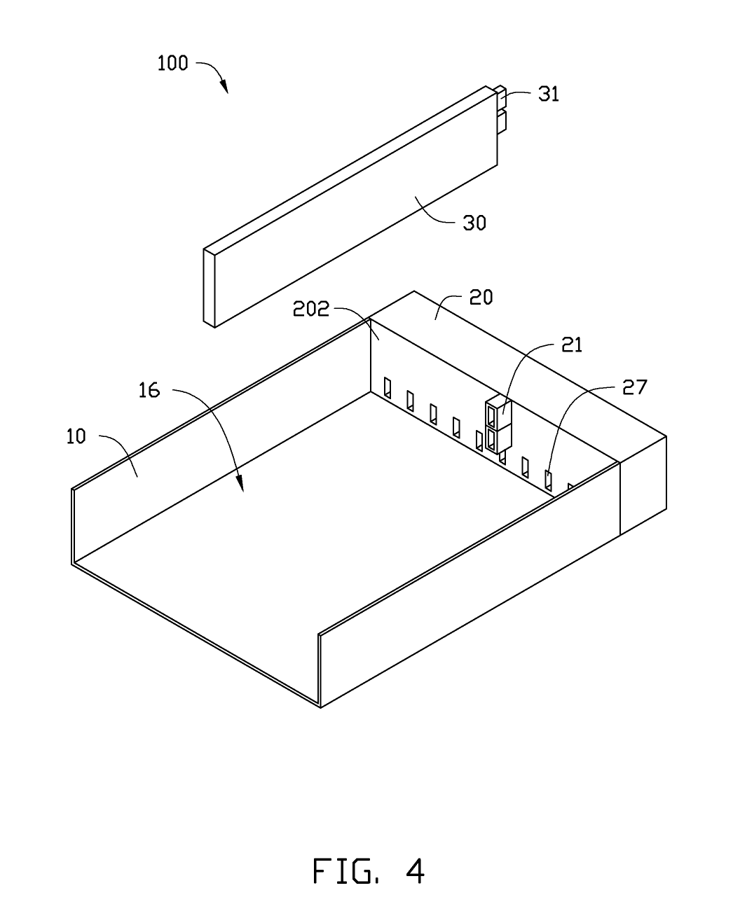

FIGS. 1 to 4, show an exemplary embodiment of a server case 100 including a main body 10, a fan module 20, a power supply device 30 and a system module 40. The main body 10 includes a rear portion where the fan module 20 is located. The power supply device 30 and the system module 40 are located in the main body 10 to electrically connect with the fan module 20.

The main body 10 includes a main section 12 and two sidewalls 14. The sidewalls 14 protrude from two opposite edges of the main section 12. The sidewalls 14 and the main section 12 all connect with the fan module 20, thereby cooperatively defining a receiving space 16, in which the power supply device 30 and the system module 40 are located.

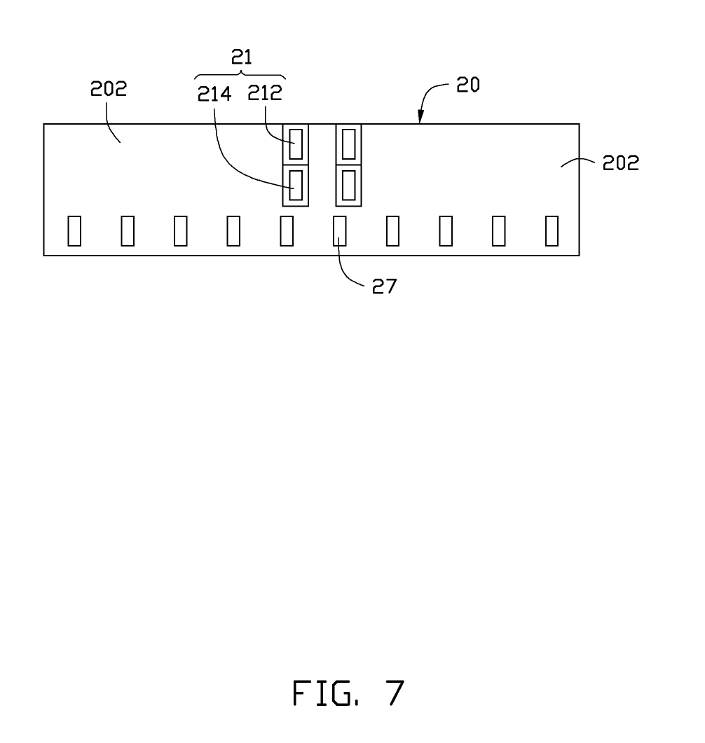

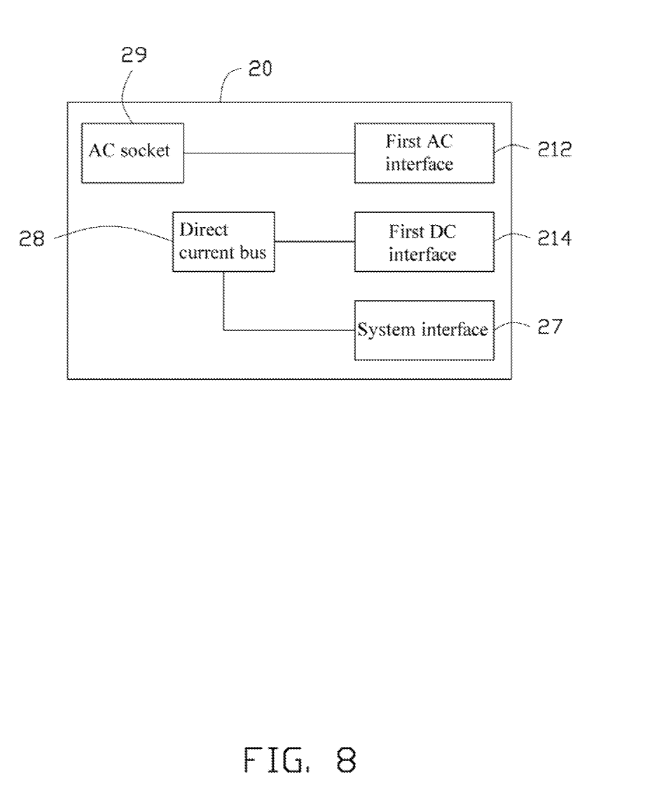

The fan module 20 includes a front wall 202 and a rear wall 204. The front wall 202 is fixed to the main body 10. The rear wall 204 is opposite the front wall 202. FIGS. 7 and 8 show that the fan module 20 further includes two sets of first power interfaces 21, a plurality of system interfaces 27, a direct current (DC) bus 28 and an alternating current (AC) socket 29. Each first power interface 21 electrically connects one of the power supply device 30. In this exemplary embodiment, each first power interface 21 includes a first alternating current (AC) interface 212 and a first direct current (DC) interface 214. The system interfaces 27 stand along a straight line. The system module 40 is inserted in one of the system interfaces 27. The first AC interface 212, first DC interface 214 and system interfaces 27 are all fixed to the front wall 202 and located in the receiving space 16. The DC bus 28 respectively and electrically connects to the first DC interface 214 and the system interfaces 27. The AC socket 29 is located on the rear wall 204. The AC socket 29 connects to an exterior AC power source to supply electricity to the server case 100. The first AC interfaces 212 are electrically connected to the AC socket 29.

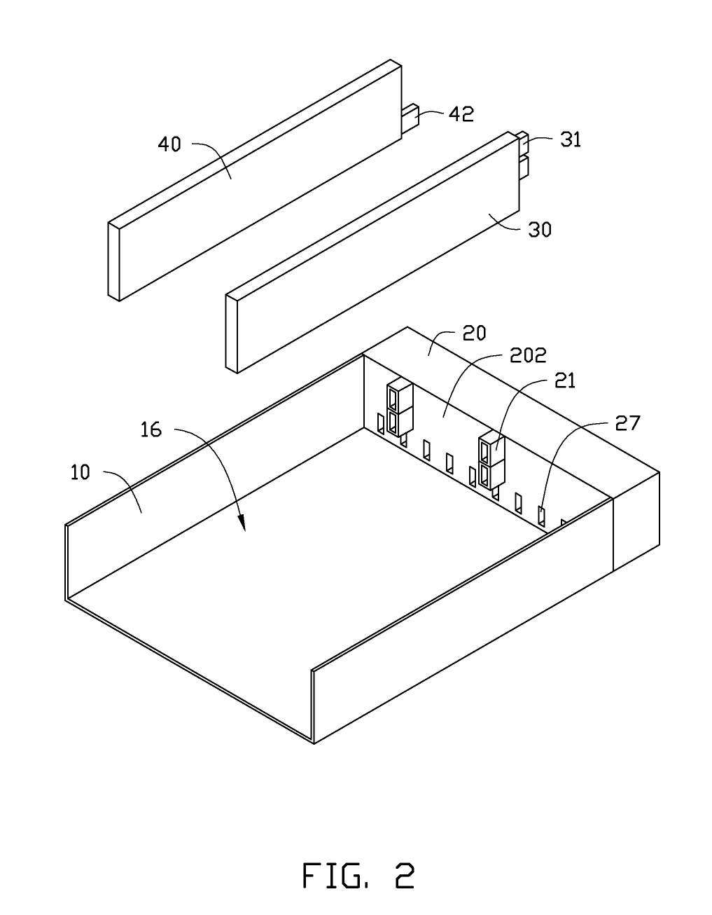

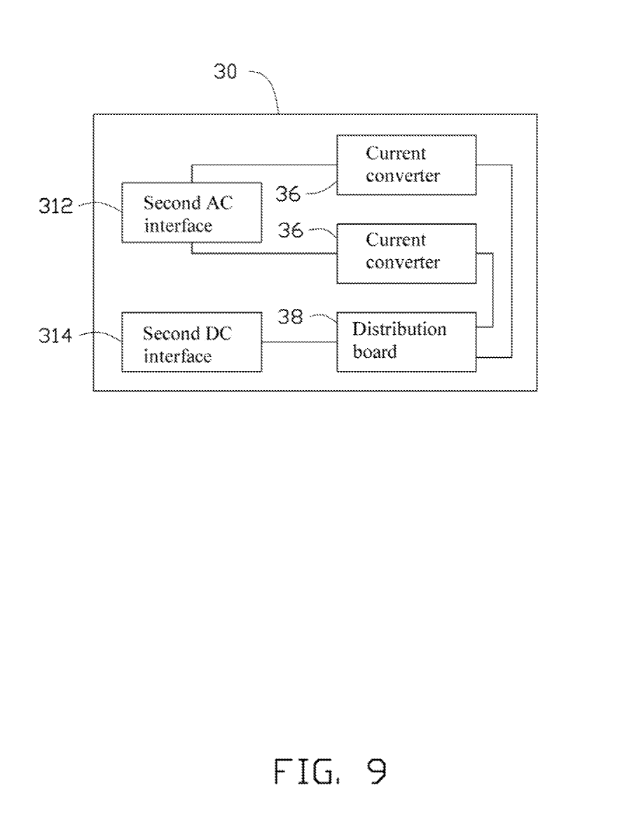

FIGS. 2 and 9 show the power supply device 30 including a second power supply interface 31, two current converters 36 and a distribution board 38. Each second power supply interface 31 includes a second AC interface 312 and a second DC interface 314. Each second AC interface 312 electrically connects with corresponding current converters 36. The distribution board 38 electrically connects with the current converters 36 and the second DC interface 314.

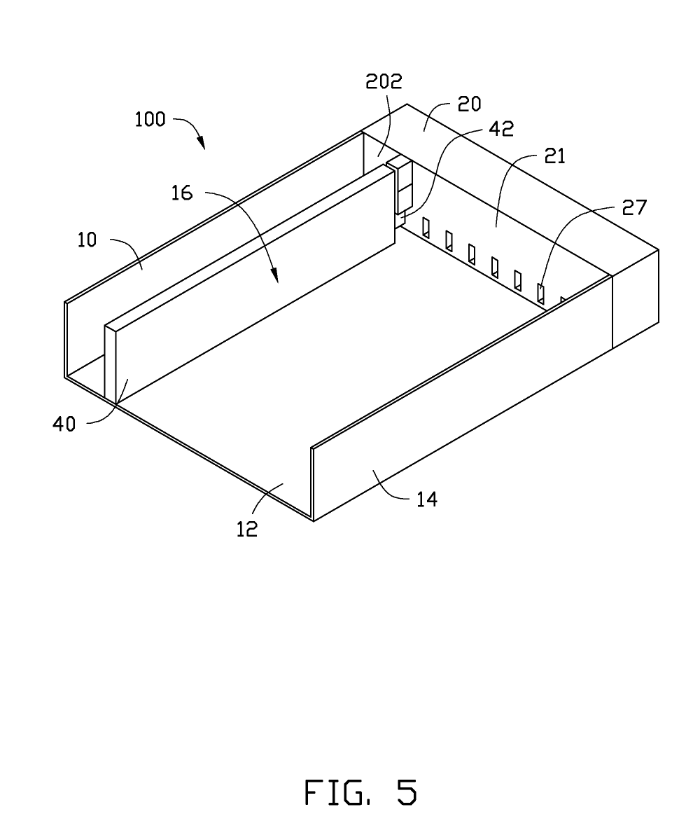

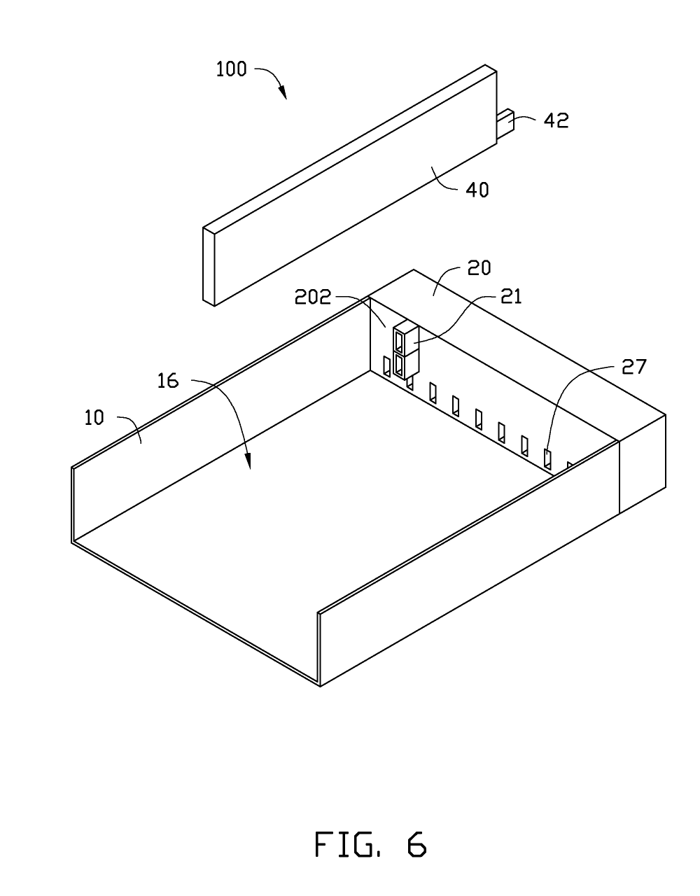

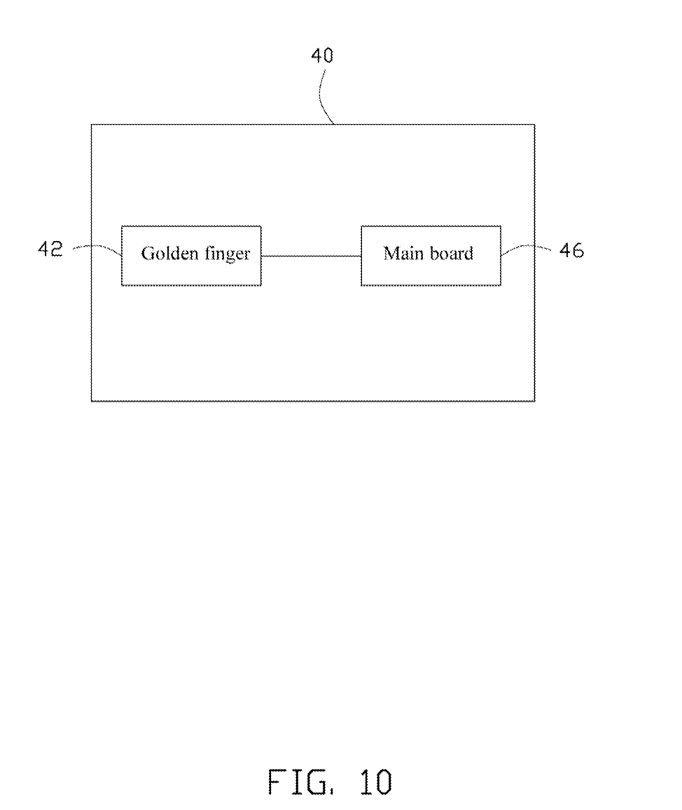

FIGS. 5, 6 and 10 show the system module 40 includes a golden finger 42 and a main board 46 electrically connecting to the golden finger 42. Each golden finger 42 is inserted into one of the system interfaces 27, so the system module 40 is electrically connected to the fan module 20.

Referring to FIGS. 1-2, 7-9, in one example of using the server case 100, the power supply device 30 and the system module 40 are both inserted to the main body 10, the details of the example is shown as below. The second AC interfaces 312 are inserted into the first AC interfaces 212 and the second DC interfaces 314 are inserted into the first DC interfaces 214 so the power supply device 30 is electrically connected to the fan module 20. The golden fingers 42 are inserted into the system interfaces 27 so the system module 40 is electrically connected to the fan module 20. The fan module 20 is electrically connected to an exterior AC power by the AC socket 29 allowing AC current from the exterior AC power to conduct to the power supply device 30 via the connections of the second AC interfaces 312 and the first AC interfaces 212. The second AC interfaces 312 transmit the AC current to the current converters 36. The current converters 36 change the AC current to DC current, and transmit the DC current to the distribution board 38. The distribution board 38 transmits the DC current to the second DC interfaces 314. Then, the DC current is transmitted to the DC bus 28 of the fan module 20 by the first DC interfaces 214. The DC current is then transmitted to the main board 46 by the connections of the golden fingers 42 and the system interfaces 27, thereby supplying electrical energy for the main board 46.

FIGS. 5-7, 8 and 10 show another example of using the server case 100 with only the system module 40 inserted in the main body 10, the details are given below. The golden fingers 42 are inserted into the system interfaces 27 so the system module 40 is electrically connected to the fan module 20. The DC bus 28 is directly and electrically connected to an exterior DC power so a DC current is transmitted to the DC bus 28 from the exterior DC. Then, the DC current is transmitted to the main board 46 by the connections of the golden fingers 42 and the system interfaces 27, thereby supplying electricity to the main board 46.

It is to be further understood that even though numerous characteristics and advantages of the exemplary embodiments have been set forth in the foregoing description, together with details of structures and functions of various embodiments, the disclosure is illustrative only, and changes may be made in detail, especially in the matters of shape, size, and arrangement of parts within the principles of the exemplary invention to the full extent indicated by the broad general meaning of the terms in which the appended claims are expressed.

What is claimed is:

1. A server case, comprising:
a main body;
a fan module being fixed at one end of the main body, the fan module comprising a front wall facing the main body, a plurality of system interfaces and a plurality of first power interfaces defined in the front wall;
a power supply device comprising a plurality of second power interfaces corresponding to the first power interfaces;
a system module comprising a plurality of golden fingers corresponding to the system interfaces;
wherein each second power interface is inserted into one of the first power interfaces so the power supply device is electrically connected to the fan module; each golden finger is inserted into one of the system interfaces so the system module is electrically connected to the fan module.

2. The server case of claim 1, wherein the main body comprises a main section and two sidewalls, the sidewalls protrude from opposite edges of the main section; the sidewalls and the main section all connect with the fan module thereby cooperatively forming a receiving space, in which the power supply device and the system module are located.

3. The server case of claim 1, wherein the first power interface comprises a first AC interface and a first DC interface; each second power supply interface comprises a second AC interface and a second DC interface; the second AC interface is inserted into the first AC interface and the second DC interface is inserted into the first DC interface so the power supply device is electrically connected to the fan module.

4. The server case of claim 3, wherein the fan module further comprises a direct DC bus and an AC socket, the DC bus electrically connects to the first DC interface and the system interface; and the first AC interface is electrically connected to the AC socket.

5. The server case of claim 3, wherein the power supply device further comprises two current converters and a distribution board; the second AC interface electrically connects with the current converters, and the distribution board electrically connects with the current converters and the second DC interface.

6. The server case of claim 1, wherein the system module further comprises a main board electrically connecting to the golden finger.

7. A server case, comprising:
a main body;
a fan module being fixed at one end of the main body, the fan module comprising a front wall facing the main body, a plurality of system interfaces and a plurality of first power interfaces defined in the front wall;
a power supply device comprising a plurality of second power interfaces corresponding to the first power interfaces;
a system module comprising a plurality of golden fingers corresponding to the system interfaces;
wherein the second power interfaces and the golden fingers are alternatively inserted into the first power interfaces and the system interfaces so the power supply device and the system module are alternatively and electrically connected to the fan module.

8. The server case of claim 7, wherein the main body comprises a main section and two sidewalls, the sidewalls protrude from opposite edges of the main section; the sidewalls and the main section all connect with the fan module, thereby cooperatively form a receiving space, in which the power supply device and the system module are located.

9. The server case of claim 7, wherein the first power interface comprises a first AC interface and a first DC interface; each second power supply interface comprises a second AC interface and a second DC interface; the second AC interface is inserted into the first AC interface and the second DC interface is inserted into the first DC interface so the power supply device is electrically connected to the fan module.

10. The server case of claim 9, wherein the fan module further comprises a direct DC bus and a AC socket, the DC bus electrically connects to the first DC interface and the system interface; the first AC interface is electrically connected to the AC socket.

11. The server case of claim 9, wherein the power supply device further comprises two current converters and a distribution board; the second AC interface electrically connects with the current converters, the distribution board electrically connects with the current converters and the second DC interface.

12. The server case of claim 7, wherein the system module further comprises a main board electrically connecting to the golden finger.
